(19) United States
(12) Patent Application Publication
(10) Pub. No.: US 2009/0097904 A1
(43) Pub. Date: Apr. 16, 2009

(54) MULTIFUNCTION APPLICATOR FOR DISPENSING FLUID

(76) Inventors: John D. Dubuc, Scottsdale, AZ (US); William J. Comeau, South Chatham, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 12/247,410

(22) Filed: Oct. 8, 2008

Related U.S. Application Data
(60) Provisional application No. 60/998,260, filed on Oct. 10, 2007.
(60) Provisional application No. 61/134,758, filed on Jul. 14, 2008.

(51) Int. Cl. B43K 29/00; B43K 8/06

(52) U.S. Cl. 401/195; 401/198

(57) ABSTRACT

A multifunction applicator for dispensing fluid is presented. The applicator includes a generally rectangular body and a dispensing tip removably disposed within a recess of the body. The applicator further includes one or more of the following: a magnifying lens disposed within the body; at least one page marker tab dispenser recess; measuring indicia disposed along a side of the body; at least one implement recess disposed within the body; and at least one grip disposed along a surface of the body.

### CROSS REFERENCE TO RELATED APPLICATIONS

The present application claims the benefit of U.S. Provisional Patent Application No. 60/998,260, filed on Oct. 10, 2007, and U.S. Provisional Patent Application No. 61/134,758, filed on Jul. 14, 2008, both of which are incorporated herein by reference in their entirety.

### BACKGROUND

For years people who read books have been using highlighters, bookmarkers, page marker tabs, and magnifiers as reading aids. The problem is these aids are all separate items that must be purchased separately and carried around in some fashion (such as compartments in book bags, purses, briefcases, and the like) so that they are accessible at the time of reading. Also, the long cylindrical pen-like shape of current highlighters is carried over from a design intended for handwritten communication. The purpose of highlighting is not to communicate by writing but to visually mark sections of text that contain information the reader finds important or interesting.

Previous attempts at integrating reading aids into one device are known and are described in U.S. Pat. No. 7,367,280 (Bookmark), U.S. Pat. No. 6,006,693 (Bookmark With Highlighter Pen), U.S. Pat. No. 5,984,558 (Combination Bookmark And Highlighter) and U.S. Published Patent Application No. 2005/0191114 (Writing Instrument With A Tape Flag Dispenser).

### SUMMARY

Conventional mechanisms such as those explained above suffer from a variety of deficiencies. Deficiencies associated with these solutions include: highlighting and book marking only, highlighting and marking multiple pages only, or highlighting one line of text at a time.

Embodiments of the invention significantly overcome such deficiencies and provide mechanisms that provide a multifunction applicator for dispensing fluid which integrates the functions of a highlighter/marker, bookmark, page marker tab dispenser, light, text magnifier, ruler and pen/pencil holder. As a result of its thin wide profile the applicator for dispensing fluid also creates a wide marking capability for highlighting multiple lines in one pass as well as single line and fine line underscoring using the same marker tip. The dispensing tip element, page marker tabs and light are replaceable or refillable in the event they become depleted or damaged.

The multifunction applicator for dispensing fluid is also applicable to a variety of art and office supply products such as dry erase whiteboard markers, indelible and washable ink markers, oil and water-based paint markers, glass and fabric markers, stationary correction fluid markers, liquid glue sticks, and liquid chalk.

The multifunction applicator for dispensing fluid integrates multiple reading aids into a single item that is flat, thin and wide and useable as a bookmark such that, when used as a bookmark, the book itself becomes a practical means of carrying multiple reading aids together as one item.

Another benefit of a thin and wide applicator for dispensing fluid is that multiple lines, such as an entire paragraph, can be highlighted in one pass. The width of the mark can be continuously varied from minimum to maximum because the resulting line width is directly proportional to the angle the user holds the applicator for dispensing fluid relative to the direction of the text. For example 90 degrees (perpendicular to a line of text) results in maximum width, where 0 degrees (parallel to a line of text) results in minimum width. In addition, the maximum dimension of the multifunction applicator for dispensing fluid tip is straight by design thus making consistently straight highlighting and underscoring of sentences easier to perform. Current highlighters require several passes if the user wishes to highlight an entire paragraph because the highlight width is relatively narrow regardless of the angle. Also, the straightness of the highlight depends on the user's hand steadiness.

Other features of the presently described multifunction applicator for dispensing fluid include a magnifier for improving readability of fine print, a supply of adhesive-backed page marker tabs, a light, one or more rulers calibrated to English and/or metric scales and a pen or pencil holder clip. These features are integral to the body of the applicator for dispensing fluid device. The dispensing tip, page marker tabs and light are replaceable or refillable in the event they become depleted, degraded or damaged. The multifunction applicator for dispensing fluid can also be configured with one of a variety of differently styled dispensing tips, including a trapezoidal shaped tip, a parallelogram shaped tip, and a triangular shaped tip. Further, each tip can have either a continuous flow edge or a raked edge.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A depicts a top view of a multifunction applicator for dispensing fluid in accordance with embodiments of the present invention;

FIG. 1B depicts a side view of the multifunction applicator for dispensing fluid of FIG. 1A;

FIG. 2A depicts a top view of a trapezoidal dispensing tip for use in a multifunction applicator for dispensing fluid in accordance with embodiments of the present invention;

FIG. 2B depicts an end view of the trapezoidal dispensing tip FIG. 2A;

FIG. 3A depicts a top view of a parallelogram dispensing tip for use in a multifunction applicator for dispensing fluid in accordance with embodiments of the present invention;

FIG. 3B depicts an end view of the parallelogram dispensing tip FIG. 3A;

FIG. 4A depicts a top view of a triangular dispensing tip for use in a multifunction applicator for dispensing fluid in accordance with embodiments of the present invention;

FIG. 4B depicts an end view of the triangular dispensing tip FIG. 4A;

FIG. 5A depicts an end view of a raked edge dispensing tip;

FIG. 5B depicts a top view of a raked edge dispensing tip;

FIG. 6A depicts a top view of a multifunction applicator for dispensing fluid incorporating a magnifying lens in accordance with embodiments of the present invention;

FIG. 6B depicts a side view of the multifunction applicator for dispensing fluid of FIG. 5A;

FIG. 7A depicts a top view of a multifunction applicator for dispensing fluid incorporating a pair of recesses in accordance with embodiments of the present invention;

FIG. 7B depicts a side view of the multifunction applicator for dispensing fluid of FIG. 6A;

FIG. 8 depicts a top view of a multifunction applicator for dispensing fluid incorporating measuring indicia in accordance with embodiments of the present invention;

FIG. 9A depicts a top view of a multifunction applicator for dispensing fluid incorporating an implement recess in accordance with embodiments of the present invention;

FIG. 9B depicts a side view of the multifunction applicator for dispensing fluid of FIG. 9A;

FIG. 9C depicts an end view of the multifunction applicator for dispensing fluid of FIG. 9A;

FIG. 10 depicts a top view of a multifunction applicator for dispensing fluid incorporating a grip in accordance with embodiments of the present invention; and

FIG. 11 depicts a top view of a multifunction applicator for dispensing fluid incorporating a magnifying lens, a pair of recesses, measuring indicia, an implement recess and a grip in accordance with embodiments of the present invention.

### DETAILED DESCRIPTION

A complete understanding of the present invention may be obtained by reference to the accompanying drawings, when considered in conjunction with the subsequent detailed description.

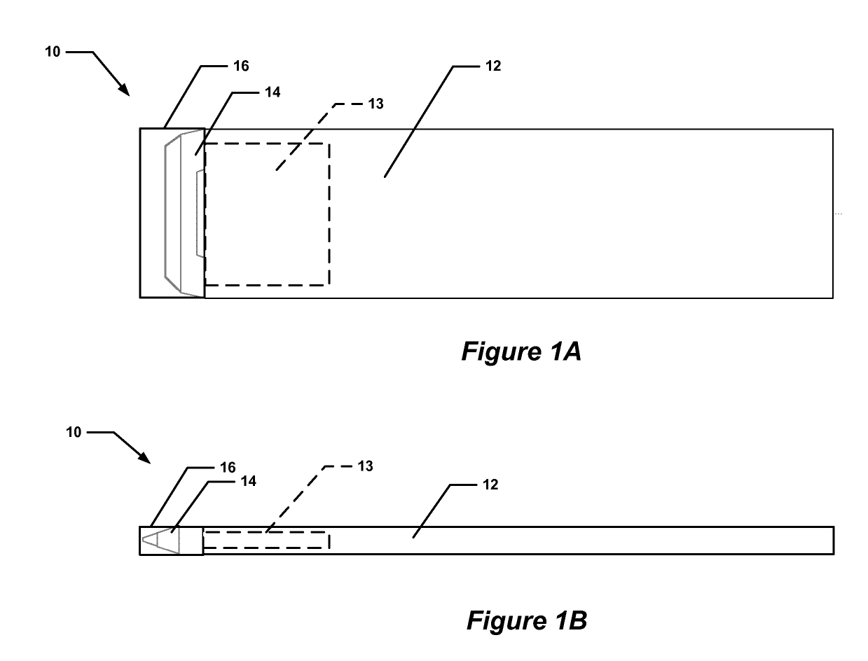

Referring to FIGS. 1A and 1B, a top view and side view respectively of the core components of the applicator for dispensing fluid 10 are shown. The applicator for dispensing fluid 10 includes a generally rectangular body 12. Body 12 includes a recess 13 for receiving a dispensing tip 14. Also shown is a cap 16 which is press-fit to reliably snap in place over the end of dispensing tip 14 and also can be fit over the back end of body 12. Additionally, cap 14 may also be magnetically secured to the opposite non-marking end of the applicator avoid misplacing the cap 14.

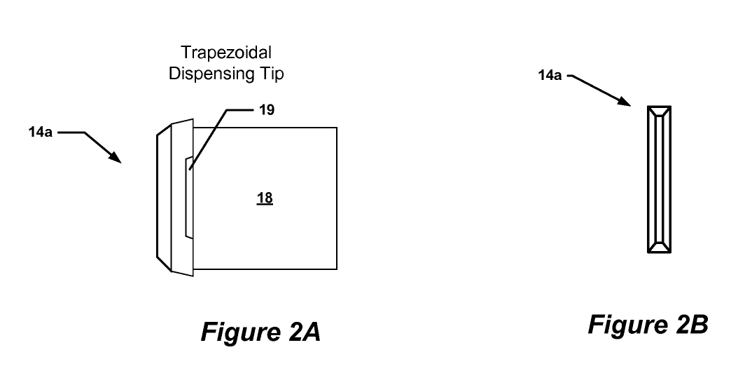

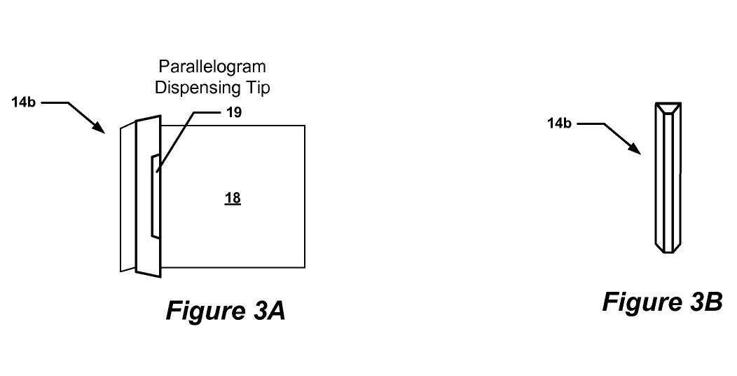

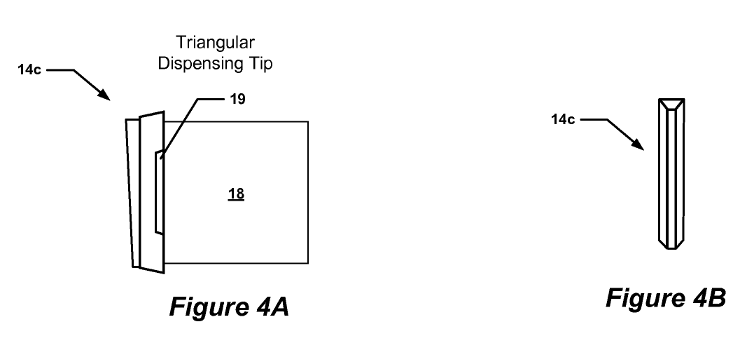

FIGS. 2A through 4B shows different designs for replaceable dispensing tips. FIGS. 2A and 2B show a trapezoidal tip geometry 14a, which enables single, multiple, and a continuum of line widths. A parallelogram tip geometry 14b shown in FIGS. 3A and 3B also enables single, multiple and a continuum of line widths as well as providing the ability to have fine line or underscoring. A triangular shaped tip 14c is shown in FIGS. 4A and 4B. The triangular shaped tip 14c enables single, multiple and a continuum of line widths as well as providing the ability to have fine line or underscoring.

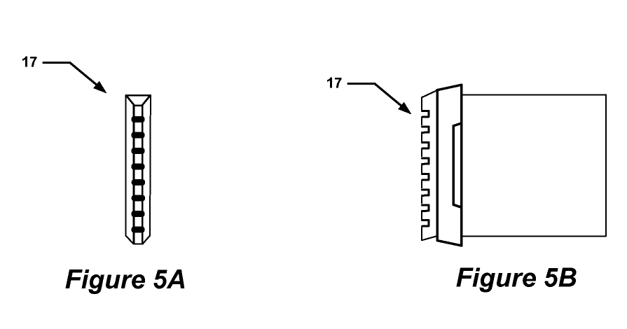

The ability to remove and replace the dispensing tips enables the dispensing tip 14 to be replaced in the event the wick 18 dries out or the tip 14 becomes damaged or degraded. The length of the wick 18 can vary to accommodate various quantities of fluid. The replaceable dispensing tip 14 also reduces environmental waste by enabling the applicator for dispensing fluid body 12 to be reused. In a particular embodiment, a collar is used for holding the dispensing tip 14 in place and attaching to the applicator for dispensing fluid body 12. The collar may include a slot 19 for receiving a coin or other device to aid in removing the dispensing tip from the body 12 of the applicator for dispensing fluid so a replacement dispensing tip can be inserted. Also, while continuous edge tips are shown in FIGS. 2A through 4B, it should be appreciated that each dispensing tip can have either a continuous flow edge or a raked edge 17 as shown in FIGS. 5A and 5B.

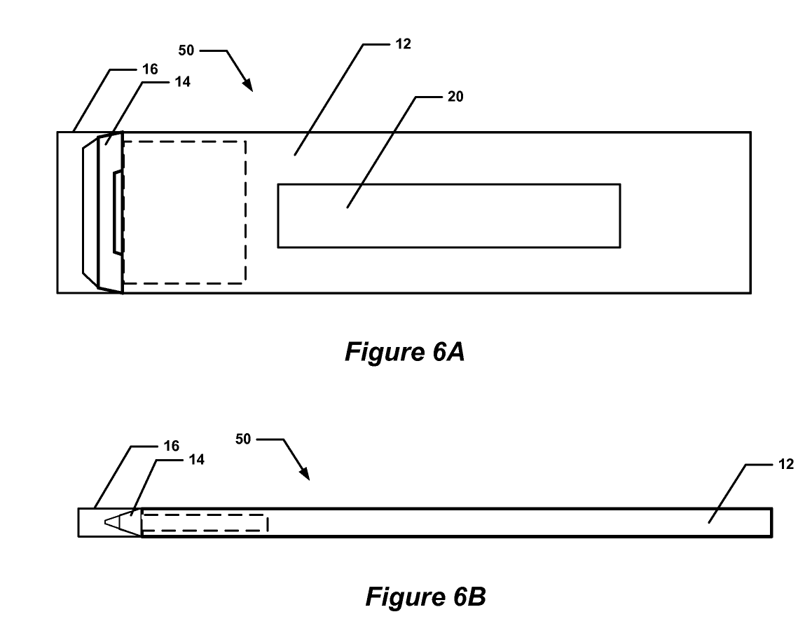

Referring now to FIGS. 6A and 6B, a first embodiment of the applicator for dispensing fluid 50 is shown. In this embodiment the applicator for dispensing fluid 50 includes a generally rectangular body 12, dispensing tip 14, and cap 16 as shown in FIG. 1, and further includes a magnifying lens 20. The lens 20 is useful for magnifying fine print and can function as an alternative to reading glasses. The magnifier lens 20 snaps or press-fits into a recess of the same size and shape in the applicator for dispensing fluid body 12.

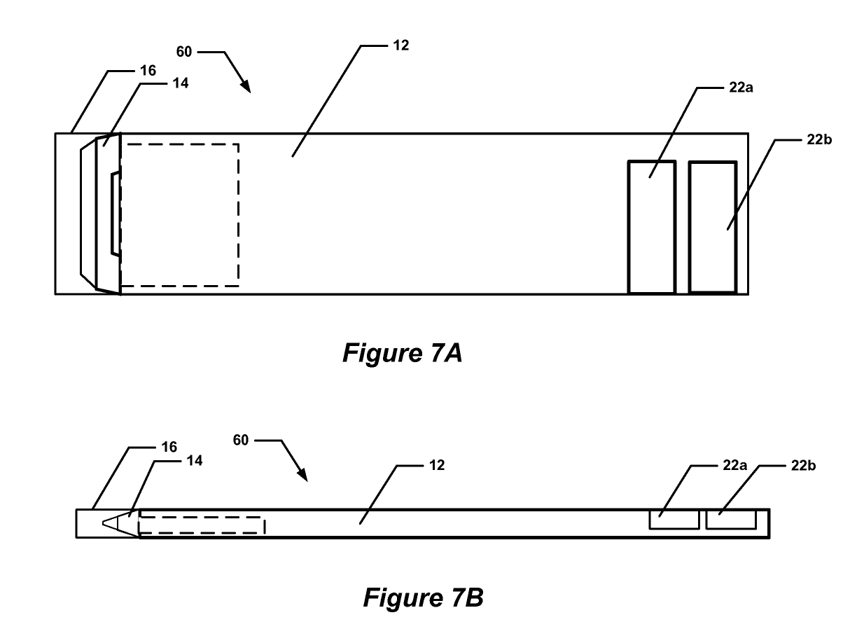

Referring now to FIGS. 7A and 7B, a second embodiment of the applicator for dispensing fluid 60 is shown. In this embodiment the applicator for dispensing fluid 60 includes a generally rectangular body 12, dispensing tip 14, and cap 16 as shown in FIG. 1, and further includes a pair of recesses 22a and 22b. Recesses 22a and 22b can be used for holding a variety of objects. One or both of recesses 22a and 22b can be used to store page marking tab dispensers that hold a quantity of adhesive-backed page tabs for marking multiple pages. Two dispensers provide the option to make different color tabs available to the user. The page tab dispensers can slide, snap, or press-fit into the corresponding recesses 22a and 22b located in the applicator for dispensing fluid body 12. Alternately, one or more of the recesses 22a and 22b can be used to store a light (e.g., a battery powered Light Emitting Diode (LED) or the like). Alternately, one recess can be used to store a page marking tab dispenser and the other recess to store a light. The detachable light conveniently allows the user to use the Multifunction Applicator for Dispensing Fluid in low light or dark conditions. In a particular embodiment, If the page dispenser recess is in mechanical communication with the lens opening such that the detachable light is capable of illuminating the magnifier lens.

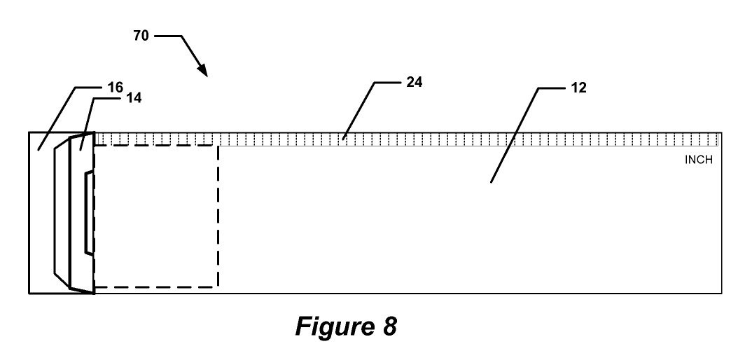

Referring now to FIG. 8, a third embodiment of the applicator for dispensing fluid 70 is shown. In this embodiment the applicator for dispensing fluid 70 includes a generally rectangular body 12, dispensing tip 14, and cap 16 as shown in FIG. 1, and further includes marking indicia 24 disposed along at least one side of the body 12. The marking indicia 24 can be used to provide a tool for measuring. The indicia 24 can be in inches (English scale), in centimeters (Metric scale), or in any other units. In a particular embodiment, the marking indicia 24 on a first side of the body 12 are in inches while a second set of marking indicia are provided on another side of the body 12 and are in centimeters.

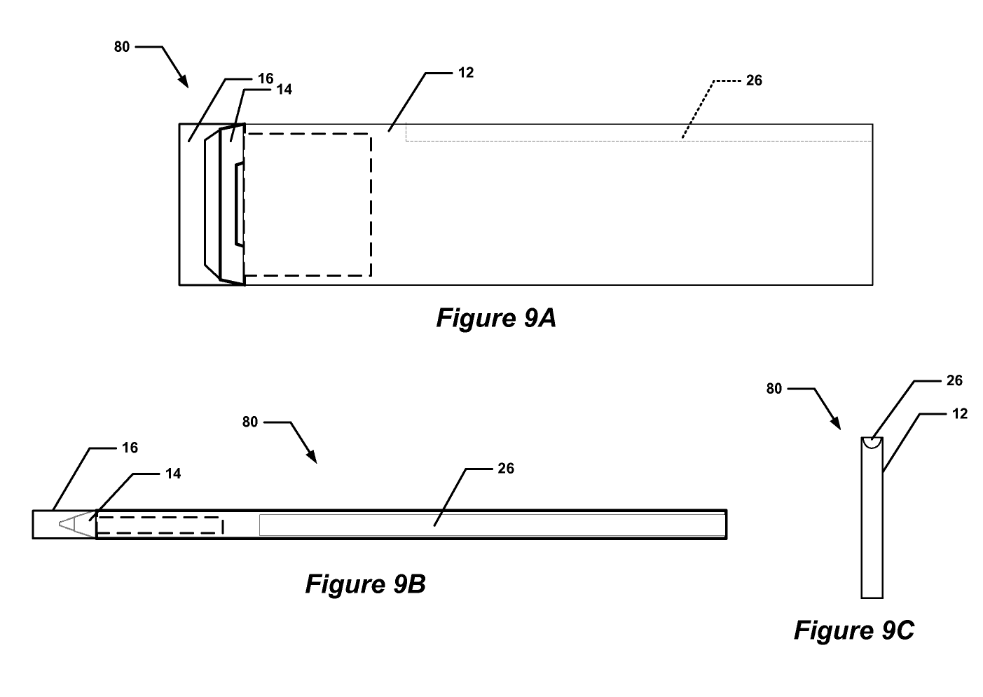

Referring now to FIGS. 9A through 9C, another embodiment of the applicator for dispensing fluid 80 is shown. In this embodiment the applicator for dispensing fluid 80 includes a generally rectangular body 12, dispensing tip 14, and cap 16 as shown in FIG. 1, and further includes at least one implement recess 26 disposed along a side edge of the body 12. Recess 26 is sized to receive and maintain an implement (e.g., pen, pencil, probe, laser pointer or the like) within body 12. The implement is stored within body 80, and is available for use by the user whenever needed. The implement can be removed from the recess 26, used, and returned back into recess 26.

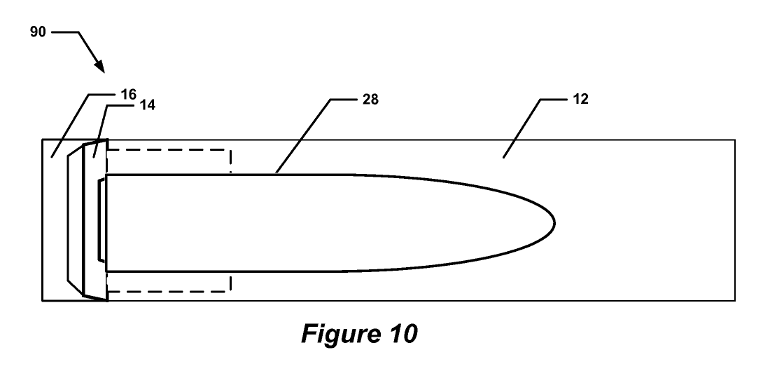

Referring now to FIG. 10, another embodiment of the applicator for dispensing fluid 90 is shown. In this embodiment the applicator for dispensing fluid 90 includes a generally rectangular body 12, dispensing tip 14, and cap 16 as shown in FIG. 1, and further includes at least one grip 28. The at least one grip 28 is disposed along a surface of body 12, and aids in the user maintaining control of the applicator for dispensing fluid 90. While one grip is shown, it should be appreciated that another grip can be disposed along an opposing side of the body 12.

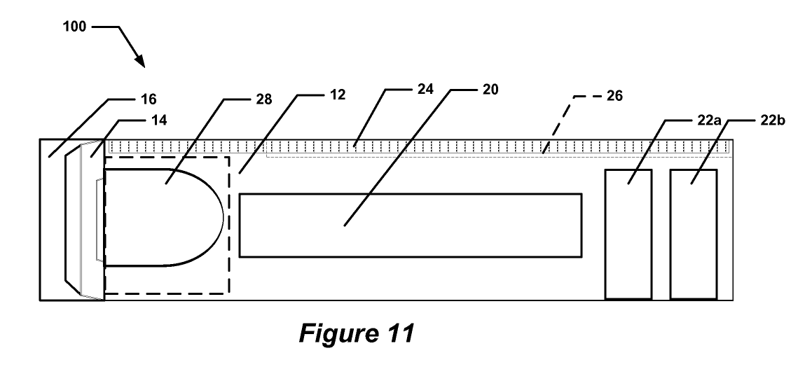

Referring now to FIG. 11, an embodiment of the applicator for dispensing fluid 100 incorporating the elements of the previously disclosed embodiments is shown. In this embodiment the applicator for dispensing fluid 100 includes a generally rectangular body 12, dispensing tip 14, and cap 16 as shown in FIG. 1, and further includes the magnifying lens 20, the recesses 22a and 22b, the measuring indicia 24, a recess for an implement 26, and a grip 28.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the device has been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims.

What is claimed is:

1. A multifunction applicator for dispensing fluid comprising:
a generally rectangular body, said body having a width and a thickness, wherein the width of said body is greater than the thickness of said body, said body having a first end and a second end, and wherein said first end includes a first recess extending from said first end into said body and a second recess extending through a central part of said body; and
a dispensing tip removably disposed within said recess of said body, wherein said dispensing tip has a width and a thickness, wherein the width of said dispensing tip is greater than the thickness of said dispensing tip; and
a magnifying lens disposed within said second recess.

2. The multifunction applicator for dispensing fluid of claim 1 wherein said dispensing tip is selected from the group consisting of a trapezoidal shaped tip, a parallelogram shaped tip, and a triangular shaped tip, wherein said trapezoidal shaped tip is capable of providing a mark having a width from about a single line of text to a plurality of lines of text, wherein said parallelogram shaped tip is capable of providing a mark having a width useable for underlining a single line of text to marking a plurality of lines of text, and wherein said triangular shaped tip is capable of providing a mark having a width useable for underlining a single line of text to marking a plurality of lines of text, and wherein said dispensing tip has one of the group consisting of a continuous flow edge and a raked edge.

3. The multifunction applicator for dispensing fluid of claim 1 further comprising a cap, said cap removably disposable over said dispensing tip and into mechanical communication with said body.

4. The multifunction applicator for dispensing fluid of claim 3 wherein said cap is magnetically securable to said body.

5. The multifunction applicator for dispensing fluid of claim 1 wherein said dispensing tip includes a reservoir, said reservoir capable of storing a quantity of fluid, said fluid selected from the group consisting of highlighting fluid, dry erase marking fluid, permanent ink, paint, correction fluid, adhesive, and liquid chalk.

6. A multifunction applicator for dispensing fluid comprising:
a generally rectangular body, said body having a width and a thickness, wherein the width of said body is greater than the thickness of said body, said body having a first end and a second end, and wherein said first end includes a first recess extending from said first end into said body; and
a dispensing tip removably disposed within said recess of said body, wherein said dispensing tip has a width and a thickness, wherein the width of said dispensing tip is greater than the thickness of said dispensing tip; and
at least one page marker tab dispenser recess disposed within said body, each of said at least one page marker tab dispenser recess capable of storing objects therein.

7. The multifunction applicator for dispensing fluid of claim 6 wherein said objects are selected from the group consisting of page marker tab dispensers and lights.

8. The multifunction applicator for dispensing fluid of claim 6 wherein said dispensing tip is selected from the group consisting of a trapezoidal shaped tip, a parallelogram shaped tip, and a triangular shaped tip, wherein said trapezoidal shaped tip is capable of providing a mark having a width from about a single line of text to a plurality of lines of text, wherein said parallelogram shaped tip is capable of providing a mark having a width useable for underlining a single line of text to marking a plurality of lines of text, and wherein said triangular shaped tip is capable of providing a mark having a width useable for underlining a single line of text to marking a plurality of lines of text, and wherein said dispensing tip has one of the group consisting of a continuous flow edge and a raked edge.

9. The multifunction applicator for dispensing fluid of claim 6 further comprising a cap, said cap removably disposable over said dispensing tip and into mechanical communication with said body.

10. The multifunction applicator for dispensing fluid of claim 9 wherein said cap is magnetically securable to said body.

11. The multifunction applicator for dispensing fluid of claim 6 wherein said dispensing tip includes a reservoir, said reservoir capable of storing a quantity of fluid, said fluid selected from the group consisting of highlighting fluid, dry erase marking fluid, permanent ink, paint, correction fluid, adhesive, and liquid chalk.

12. A multifunction applicator for dispensing fluid comprising:
a generally rectangular body, said body having a width and a thickness, wherein the width of said body is greater than the thickness of said body, said body having a first end and a second end, and wherein said first end includes a first recess extending from said first end into said body; and
a dispensing tip removably disposed within said recess of said body, wherein said dispensing tip has a width and a thickness, wherein the width of said dispensing tip is greater than the thickness of said dispensing tip; and
a plurality of measuring indicia disposed along a side of said body, said measuring indicia useful for taking measurements.

13. The multifunction applicator for dispensing fluid of claim 12 wherein said dispensing tip is selected from the group consisting of a trapezoidal shaped tip, a parallelogram shaped tip, and a triangular shaped tip, wherein said trapezoidal shaped tip is capable of providing a mark having a width from about a single line of text to a plurality of lines of text, wherein said parallelogram shaped tip is capable of providing a mark having a width useable for underlining a single line of text to marking a plurality of lines of text, and wherein said triangular shaped tip is capable of providing a mark having a width useable for underlining a single line of text to marking a plurality of lines of text, and wherein said dispensing tip has one of the group consisting of a continuous flow edge and a raked edge.

14. The multifunction applicator for dispensing fluid of claim 12 further comprising a cap, said cap removably disposable over said dispensing tip and into mechanical communication with said body.

15. The multifunction applicator for dispensing fluid of claim 14 wherein said cap is magnetically securable to said body.

16. The multifunction applicator for dispensing fluid of claim 12 wherein said dispensing tip includes a reservoir, said reservoir capable of storing a quantity of fluid, said fluid selected from the group consisting of highlighting fluid, dry erase marking fluid, permanent ink, paint, correction fluid, adhesive, and liquid chalk.

17. A multifunction applicator for dispensing fluid comprising:
a generally rectangular body, said body having a width and a thickness, wherein the width of said body is greater than the thickness of said body, said body having a first end and a second end, and wherein said first end includes a first recess extending from said first end into said body; and
a dispensing tip removably disposed within said recess of said body, wherein said dispensing tip has a width and a thickness, wherein the width of said dispensing tip is greater than the thickness of said dispensing tip; and
at least one implement recess disposed within said body, said at least one implement recess capable of storing a implement therein.

18. The multifunction applicator for dispensing fluid of claim 17 wherein said dispensing tip is selected from the group consisting of a trapezoidal shaped tip, a parallelogram shaped tip, and a triangular shaped tip, wherein said trapezoidal shaped tip is capable of providing a mark having a width from about a single line of text to a plurality of lines of text, wherein said parallelogram shaped tip is capable of providing a mark having a width useable for underlining a single line of text to marking a plurality of lines of text, and wherein said triangular shaped tip is capable of providing a mark having a width useable for underlining a single line of text to marking a plurality of lines of text, and wherein said dispensing tip has one of the group consisting of a continuous flow edge and a raked edge.

19. The multifunction applicator for dispensing fluid of claim 17 further comprising a cap, said cap removably disposable over said dispensing tip and into mechanical communication with said body.

20. The multifunction applicator for dispensing fluid of claim 19 wherein said cap is magnetically securable to said body.

21. The multifunction applicator for dispensing fluid of claim 17 wherein said dispensing tip includes a reservoir, said reservoir capable of storing a quantity of fluid, said fluid selected from the group consisting of highlighting fluid, dry erase marking fluid, permanent ink, paint, correction fluid, adhesive, and liquid chalk.

22. A multifunction applicator for dispensing fluid comprising:
a generally rectangular body, said body having a width and a thickness, wherein the width of said body is greater than the thickness of said body, said body having a first end and a second end, and wherein said first end includes a first recess extending from said first end into said body; and
a dispensing tip removably disposed within said recess of said body, wherein said dispensing tip has a width and a thickness, wherein the width of said dispensing tip is greater than the thickness of said dispensing tip; and
at least one grip disposed along a surface of said body.

23. The multifunction applicator for dispensing fluid of claim 22 wherein said dispensing tip is selected from the group consisting of a trapezoidal shaped tip, a parallelogram shaped tip, and a triangular shaped tip, wherein said trapezoidal shaped tip is capable of providing a mark having a width from about a single line of text to a plurality of lines of text, wherein said parallelogram shaped tip is capable of providing a mark having a width useable for underlining a single line of text to marking a plurality of lines of text, and wherein said triangular shaped tip is capable of providing a mark having a width useable for underlining a single line of text to marking a plurality of lines of text, and wherein said dispensing tip has one of the group consisting of a continuous flow edge and a raked edge.

24. The multifunction applicator for dispensing fluid of claim 22 further comprising a cap, said cap removably disposable over said dispensing tip and into mechanical communication with said body.

25. The multifunction applicator for dispensing fluid of claim 24 wherein said cap is magnetically securable to said body.

26. The multifunction applicator for dispensing fluid of claim 22 wherein said dispensing tip includes a reservoir, said reservoir capable of storing a quantity of fluid, said fluid selected from the group consisting of highlighting fluid, dry erase marking fluid, permanent ink, paint, correction fluid, adhesive, and liquid chalk.
